(19) United States
(12) Patent Application Publication
(10) Pub. No.: US 2023/0131695 A1
(43) Pub. Date: Apr. 27, 2023

(54) TRACK SYSTEM FOR TRACTION OF A VEHICLE

(71) Applicant: CAMSO INC., Magog (CA)

(72) Inventor: Dwight FURLEIGH, Tonica, IL (US)

(73) Assignee: CAMSO INC., Magog, QC (CA)

(21) Appl. No.: 17/798,716

(22) PCT Filed: Feb. 11, 2021
(86) PCT No.: PCT/US2021/017646

§ 371 Date: Aug. 10, 2022

Related U.S. Application Data
(60) Provisional application No. 62/972,770, filed on Feb. 11, 2020.

(51) Int. Cl. B62D 55/065; B62D 55/30; B62D 55/10; B62D 55/14

(52) U.S. Cl. CPC B62D 55/065; B62D 55/30; B62D 55/10; B62D 55/14

(57) ABSTRACT

A track system for traction of a vehicle in which the track system is designed to enhance durability (e.g., protect against abnormal wear and/or prevent premature failure) of a track and/or other components of the track system, traction, and/or other aspects of performance of the track system by improving alignment of the track, such as by aligning the track in a rear region (e.g., at a rear wheel) of the track system.

### CROSS-REFERENCE TO RELATED APPLICATION

This application claims priority from U.S. Patent Application 62/972,770 filed on Feb. 11, 2020 and hereby incorporated by reference herein.

### FIELD

This disclosure relates generally to vehicles (e.g., agricultural vehicles or other industrial vehicles, etc.) and, more particularly, to track systems for traction of vehicles.

### BACKGROUND

Off-road vehicles, including agricultural vehicles (e.g., tractors, harvesters, combines, etc.), construction vehicles (e.g., loaders, excavators, bulldozers, etc.), and forestry vehicles (e.g., feller-bunchers, knuckleboom loaders, etc.), military vehicles (e.g., combat engineering vehicles (CEVs), etc.), snowmobiles, and all-terrain vehicles (ATVs), may comprise track systems to enhance their traction and floatation on soft, slippery, and/or irregular grounds (e.g., soil, mud, etc.).

During using, tracks of the track systems may move relative to a track assembly of the track system, causing stress concentration, abnormal wear and premature failure. To remedy this, a current industry approach is to provide an adjusting mechanism at a front end of the track systems to provide alignment adjustment at the front end of the track systems. However, in this configuration, the adjusting mechanisms and the tracks are subject to high stresses which compromise the alignment adjustment and cause abnormal wear and premature failure.

For these and other reasons, improvements for track systems of vehicles would be welcomed.

### SUMMARY

According to various aspects, this disclosure relates to a track system for traction of a vehicle in which the track system is designed to enhance durability (e.g., protect against abnormal wear and/or prevent premature failure) of a track and/or other components of the track system, traction, and/or other aspects of performance of the track system by improving alignment of the track, such as by aligning the track in a rear region (e.g., at a rear wheel) of the track system.

For example, according to an aspect, this disclosure relates to a track system for traction of a vehicle. The track system comprises: a track that is elastomeric and comprises a ground-engaging outer surface configured to engage a ground and an inner surface opposite to the ground-engaging outer surface; and a plurality of track-contacting wheels for driving and guiding the track around the track-contacting wheels. The track-contacting wheels include: a drive wheel configured to drive the track; a front idler wheel and a rear idler wheel spaced apart in a longitudinal direction of the track system; and a plurality of roller wheels configured to roll on a lower run of the track and disposed between the front idler wheel and the rear idler wheel in the longitudinal direction of the track system. The track system comprises an alignment mechanism configured to adjust an orientation of the rear idler wheel relative to the longitudinal direction of the track system.

According to another aspect, this disclosure relates to a track system for traction of a vehicle. The track system comprises: a track that is elastomeric and comprises a ground-engaging outer surface configured to engage a ground and an inner surface opposite to the ground-engaging outer surface; and a plurality of track-contacting wheels for driving and guiding the track around the track-contacting wheels. The track-contacting wheels include: a drive wheel configured to drive the track; a front idler wheel and a rear idler wheel spaced apart in a longitudinal direction of the track system; and a plurality of roller wheels configured to roll on a lower run of the track and disposed between the front idler wheel and the rear idler wheel in the longitudinal direction of the track system. The track system comprises: a tensioner configured to control a tension of the track, the tensioner being disposed to exert a force closer to the front idler wheel than to the rear idler wheel to control the tension of the track; and an alignment mechanism configured to adjust an orientation of the rear idler wheel relative to the longitudinal direction of the track system.

According to another aspect, this disclosure relates to a track system for traction of a vehicle. The track system comprises: a track that is elastomeric and comprises a ground-engaging outer surface configured to engage a ground and an inner surface opposite to the ground-engaging outer surface; and a plurality of track-contacting wheels for driving and guiding the track around the track-contacting wheels. The track-contacting wheels include: a drive wheel configured to drive the track; a front idler wheel and a rear idler wheel spaced apart in a longitudinal direction of the track system; and a plurality of roller wheels configured to roll on a lower run of the track and disposed between the front idler wheel and the rear idler wheel in the longitudinal direction of the track system. The track system comprises: a tensioner configured to control a tension of the track, the tensioner being disposed to exert a force closer to the rear idler wheel than to the front idler wheel to control the tension of the track; and an alignment mechanism configured to adjust an orientation of the rear idler wheel relative to the longitudinal direction of the track system.

According to another aspect, this disclosure relates to a track system for traction of a vehicle. The track system comprises: a track that is elastomeric and comprises a ground-engaging outer surface configured to engage a ground and an inner surface opposite to the ground-engaging outer surface; and a plurality of track-contacting wheels for driving and guiding the track around the track-contacting wheels. The track-contacting wheels include: a drive wheel configured to drive the track; a front idler wheel and a rear idler wheel spaced apart in a longitudinal direction of the track system; and a plurality of roller wheels configured to roll on a lower run of the track and disposed between the front idler wheel and the rear idler wheel in the longitudinal direction of the track system. The track system comprises an alignment mechanism configured to adjust an orientation of the rear idler wheel relative to the longitudinal direction of the track system in response to a command from a processing apparatus.

These and other aspects of this disclosure will now become apparent to those of ordinary skill in the art upon review of a description of embodiments in conjunction with accompanying drawings.

### BRIEF DESCRIPTION OF DRAWINGS

A detailed description of embodiments is provided below, by way of example only, with reference to the accompanying drawings, in which:

FIG. 1 shows an example of an agricultural vehicle comprising a track system in accordance with an embodiment;

FIG. 2 shows a perspective view of the track system;

FIGS. 3A to 3C show a top view of a bottom portion of a track-engaging assembly of the track system at different positions;

FIGS. 4 and 5 show a plan view and a side view of a track of the track system;

FIG. 6 shows an inside view of the track;

FIG. 7 shows a cross-sectional view of the track;

FIG. 8 shows a perspective view of a drive/guide projection of the track;

FIG. 9 shows a drive wheel of a track-engaging assembly of the track system;

FIG. 10 shows idler wheels of the track-engaging assembly engaging an inner side the track;

FIG. 11 shows a perspective view of an idler wheel of the track-engaging assembly;

FIGS. 12 and 13 show perspective views of a mid-roller of the track-engaging assembly;

FIGS. 14 and 15 show a front view and a side view of the mid-roller;

FIGS. 16 to 18 show variants of the track-engaging assembly;

FIG. 19 shows an example of a construction vehicle comprising the track systems; and

FIG. 20 shows an example of a trailed vehicle configured to be attached to the vehicle of FIG. 1 or 19.

It is to be expressly understood that the description and drawings are only for purposed of illustrating certain embodiments and are an aid for understanding. They are not intended to be and should not be limiting.

### DETAILED DESCRIPTION OF EMBODIMENTS

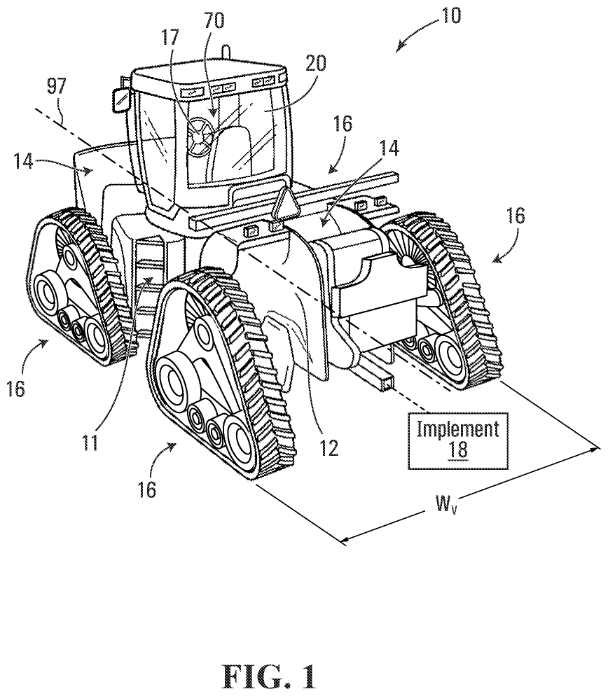

FIG. 1 shows an embodiment of a vehicle 10 comprising track systems 16 including tracks 22 for traction of the vehicle 10 on a ground. In this embodiment, the vehicle 10 is an agricultural vehicle for performing agricultural work on an agricultural field. Specifically, in this example, the agricultural vehicle 10 is a tractor and the agricultural field 11 comprises soil. In other examples, the agricultural vehicle 10 may be a combine harvester, another type of harvester, or any other type of agricultural vehicle.

The agricultural vehicle 10 comprises a frame 12, a powertrain 15, the track systems 16 (which can be referred to as “undercarriages”), and an operator cabin 20 that enable an operator to move the agricultural vehicle 10 on the ground. The vehicle 10 can travel on the agricultural field to perform agricultural work using a work implement 18. The vehicle 10 can also be “roading”, i.e., travelling on a road (i.e., a paved road having a hard surface of asphalt, concrete, gravel, or other pavement), such as between agricultural fields.

In this embodiment, as further discussed later, the track systems 16 are designed to enhance durability (e.g., protect against abnormal wear and/or prevent premature failure) of their tracks 22 and/or other components, traction, and/or other aspects of their performance by improving alignment of their tracks 22, such as by aligning their tracks 22 in rear regions (e.g., at rear wheels) of the track systems 16.

The powertrain 15 is configured for generating motive power and transmitting motive power to the track systems 16 to propel the agricultural vehicle 10 on the ground. To that end, the powertrain 15 comprises a prime mover 14, which is a source of motive power that comprises one or more motors. For example, in this embodiment, the prime mover 14 comprises an internal combustion engine. In other embodiments, the prime mover 14 may comprise another type of motor (e.g., an electric motor) or a combination of different types of motor (e.g., an internal combustion engine and an electric motor). The prime mover 14 is in a driving relationship with the track systems 16. That is, the powertrain 15 transmits motive power generated by the prime mover 14 to one or more of the track systems 16 in order to drive (i.e., impart motion to) these one or more of the track systems 16. The powertrain 15 may transmit power from the prime mover 14 to the track systems 16 in any suitable way. In this embodiment, the powertrain 15 comprises a transmission between the prime mover 14 and final drive axles 56₁, 56₂ for transmitting motive power from the prime mover 14 to the track systems 16. The transmission may be an automatic transmission (e.g., a continuously variable transmission (CVT)) or any other suitable type of transmission.

The work implement 18 is used to perform agricultural work. For example, in some embodiments, the work implement 18 may be a combine head, a cutter, a scraper pan, a tool bar, a planter, or any other type of agricultural work implement.

The operator cabin 20 is where the operator sits and controls the agricultural vehicle 10. More particularly, the operator cabin 20 comprises a user interface 70 including a set of controls that allow the operator to steer the agricultural vehicle 10 on the ground and operate the work implement 18. For example, in this embodiment, the user interface 70 comprises an accelerator, a brake control, and a steering device that are operable by the operator to control motion of the agricultural vehicle 10 on the ground and operation of the work implement 18. The user interface 70 also comprises an instrument panel (e.g., a dashboard) which provides indicators (e.g., a speedometer indicator, a tachometer indicator, etc.) to convey information to the operator.

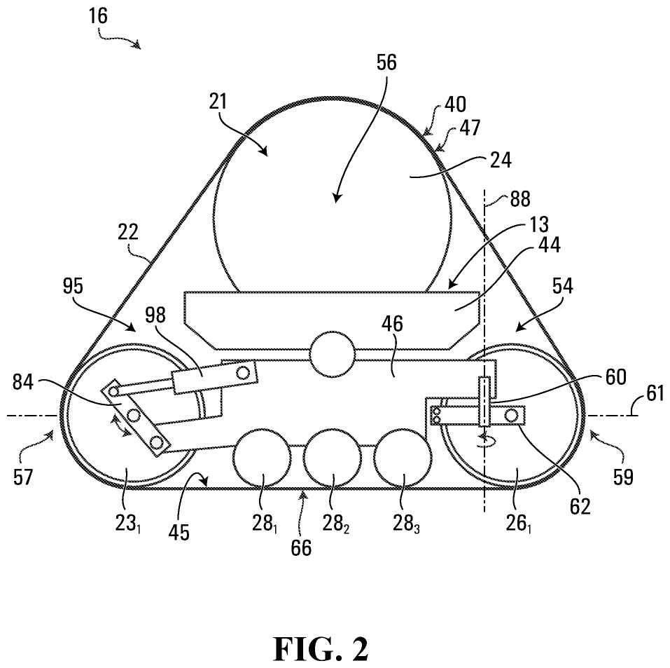

The track systems 16 engage the ground to propel the agricultural vehicle 10. As shown in FIG. 2, each track system 16 comprises a track-engaging assembly 21 and a track 22 disposed around the track-engaging assembly 21. In this embodiment, the track-engaging assembly 21 comprises a plurality of track-contacting wheels which, in this example, includes a drive wheel 24 and a plurality of idler wheels that includes front (i.e., leading) idler wheels 23₁, 23₂, rear (i.e., trailing) idler wheels 26₁, 26₂, and roller wheels 28₁-28₆. The track system 16 also comprises a frame 13 which supports various components of the track system 16, including the wheels 23₁, 23₂, 26₁, 26₂, 28₁-28₆ the frame. In particular, in this embodiment, the frame 13 comprises an upper portion 44 and a lower portion 46 movable relative to the upper portion 44 (e.g., rotatably movable about a pivot axis that is substantially parallel to a widthwise direction of the track system 16), and the lower portion 46 of the frame 13 carries the idler wheels 23₁, 23₂, 26₁, 26₂ and the roller wheels 28₁-28₆ are disposed between the front idler wheels 23₁, 23₂ and the rear idler wheels 26₁, 26₂ in a longitudinal direction of the track system 16. The track system 16 has the longitudinal direction and a first longitudinal end 57 and a second longitudinal end 59 that define a length of the track system 16 along a longitudinal axis 61 that defines the longitudinal direction of the track system 16. The track system 16 has a widthwise direction and a width that is defined by a width W of the track 22. The track system 16 also has a heightwise direction that is normal to its longitudinal direction and its widthwise direction.

Each of the front ones of the track systems 16 is steerable by the steering system 17 of the agricultural vehicle 10 in response to input of the user at the steering device to change an orientation of that track system relative to the frame 12 of the agricultural vehicle 10 in order to steer the agricultural vehicle 10 on the ground. To that end, each of the front ones of the track systems 16 is pivotable about a steering axis 25 of the agricultural vehicle 10. An orientation of the longitudinal axis 61 of each of the front ones of the track systems 16 is thus adjustable relative to a longitudinal axis 97 of the agricultural vehicle 10.

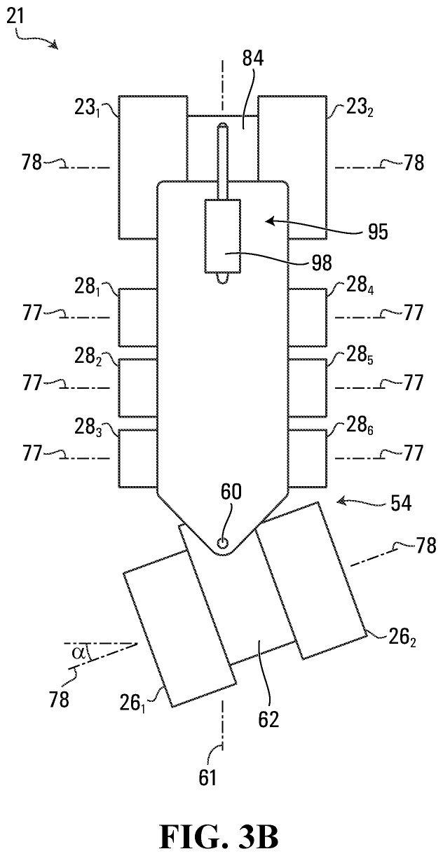

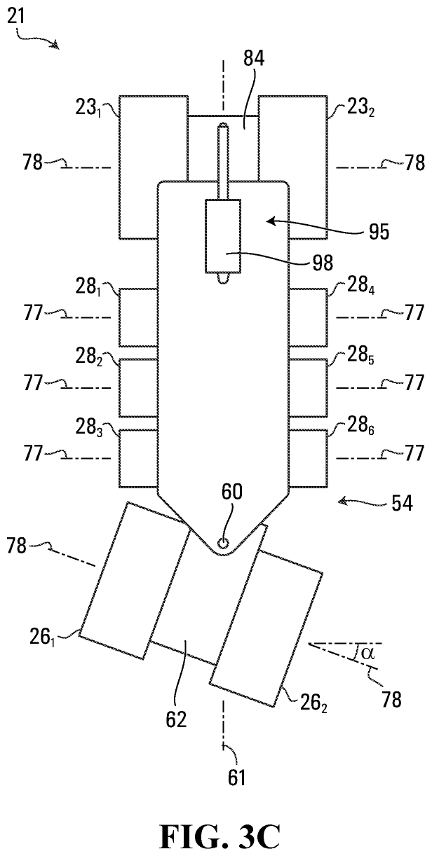

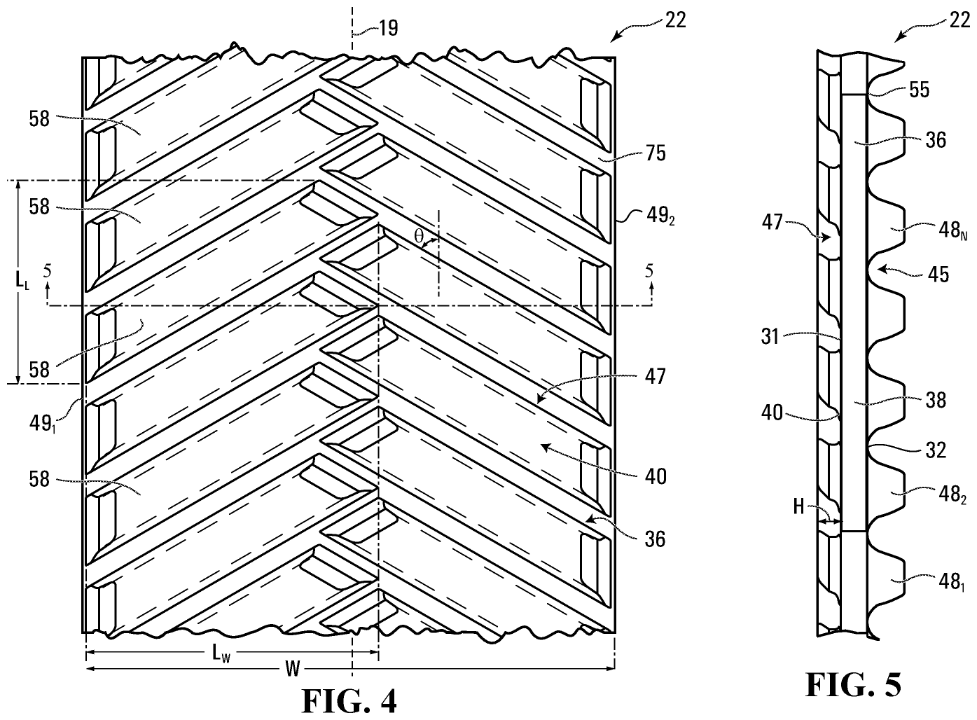

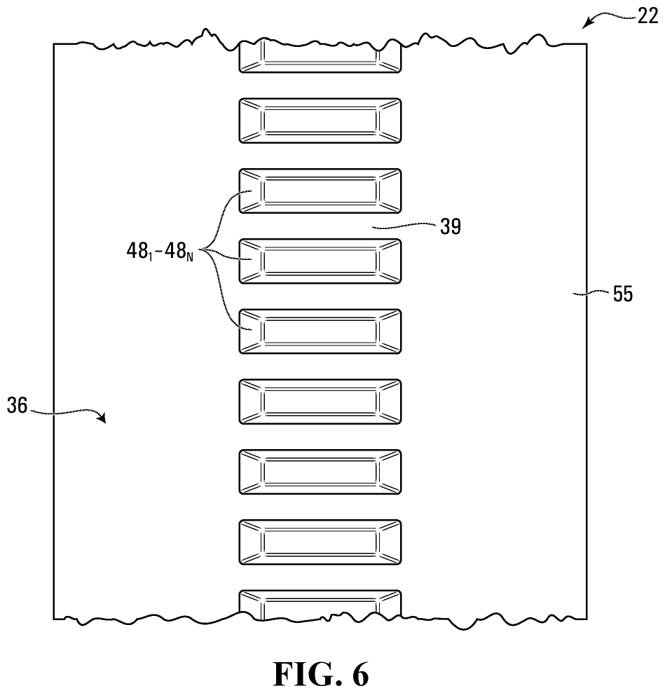

The track 22 engages the ground to provide traction to the agricultural vehicle 10. A length of the track 22 allows the track 22 to be mounted around the track-engaging assembly 21. In view of its closed configuration without ends that allows it to be disposed and moved around the track-engaging assembly 21, the track 22 can be referred to as an “endless” track. With additional reference to FIGS. 4 to 6, the track 22 comprises an inner side 45, a ground-engaging outer side 47, and lateral edges 49₁, 49₂. The inner side 45 faces the wheels 23₁, 23₂, 24, 26₁, 26₂, 28₁-28₆, while the ground-engaging outer side 47 engages the ground. A top run 65 of the track 22 extends between the longitudinal ends 57, 59 of the track system 16 and over the wheels 23₁, 23₂, 24, 26₁, 26₂, 28₁-28₆, while a bottom run 66 of the track 22 extends between the longitudinal ends 57, 59 of the track system 16 and under the wheels 23₁, 23₂, 24, 26₁, 26₂, 28₁-28₆. The bottom run 66 of the track 22 defines an area of contact 63 of the track 22 with the ground which generates traction and bears a majority of a load on the track system 16, and which will be referred to as a “contact patch” of the track 22 with the ground. The track 22 has a longitudinal axis 19 which defines a longitudinal direction of the track 22 (i.e., a direction generally parallel to its longitudinal axis) and transversal directions of the track 22 (i.e., directions transverse to its longitudinal axis), including a widthwise direction of the track 22 (i.e., a lateral direction generally perpendicular to its longitudinal axis). The track 22 has a thickness direction normal to its longitudinal and widthwise directions.

In this embodiment, the track 22 is relatively narrow. For instance, this may be helpful to allow the track 22 to fit between rows of crops such as to leave the crops undisturbed when the agricultural vehicle 10 traverses an agricultural field. In turn, this may allow the agricultural field to have a greater crop density. For instance, in some embodiments, a ratio of a width Wᵥ of the agricultural vehicle 10 (measured between laterally-outwardmost ones of the track systems 16) over the width W of the track 22 may be at least 5, in some cases at least 7, in some cases at least 10, in some cases at least 12, and in some cases even more. For example, in some embodiments, the width W of the track 22 may no more than 30 inches, in some cases no more than 25 inches, in some cases no more than 20 inches, in some cases no more than 18 inches, in some cases no more than 16 inches, and in some cases even less (e.g., 14.5 inches). The width W of the track 22 may have any other suitable value in other embodiments.

The track 22 is elastomeric, i.e., comprises elastomeric material, to be flexible around the track-engaging assembly 21. The elastomeric material of the track 22 can include any polymeric material with suitable elasticity. In this embodiment, the elastomeric material of the track 22 includes rubber. Various rubber compounds may be used and, in some cases, different rubber compounds may be present in different areas of the track 22. In other embodiments, the elastomeric material of the track 22 may include another elastomer in addition to or instead of rubber (e.g., polyurethane elastomer).

More particularly, the track 22 comprises an endless body 36 underlying its inner side 45 and ground-engaging outer side 47. In view of its underlying nature, the body 36 will be referred to as a “carcass”. The carcass 36 is elastomeric in that it comprises elastomeric material 38 which allows the carcass 36 to elastically change in shape and thus the track 22 to flex as it is in motion around the track-engaging assembly 21.

In this embodiment, the carcass 36 comprises a plurality of reinforcements embedded in its elastomeric material 38. These reinforcements can take on various forms.

For example, in this embodiment, the carcass 36 comprises a layer of reinforcing cables 37₁-37_{M} that are adjacent to one another and extend generally in the longitudinal direction of the track 22 to enhance strength in tension of the track 22 along its longitudinal direction. In this case, each of the reinforcing cables 37₁-37_{M} is a cord including a plurality of strands (e.g., textile fibers or metallic wires). In other cases, each of the reinforcing cables 37₁-37_{M} may be another type of cable and may be made of any material suitably flexible along the cable's longitudinal axis (e.g., fibers or wires of metal, plastic or composite material).

As another example, in this embodiment, the carcass 36 comprises a layer of reinforcing fabric 43. The reinforcing fabric 43 comprises thin pliable material made usually by weaving, felting, knitting, interlacing, or otherwise crossing natural or synthetic elongated fabric elements, such as fibers, filaments, strands and/or others, such that some elongated fabric elements extend transversally to the longitudinal direction of the track 22 to have a reinforcing effect in a transversal direction of the track 22. For instance, the reinforcing fabric 43 may comprise a ply of reinforcing woven fibers (e.g., nylon fibers or other synthetic fibers).

The carcass 36 may be molded into shape in a molding process during which the rubber 38 is cured. For example, in this embodiment, a mold may be used to consolidate layers of rubber providing the rubber 38 of the carcass 36, the reinforcing cables 37₁-37_{M} and the layer of reinforcing fabric 43.

The inner side 45 of the endless track 22 comprises an inner surface 55 of the carcass 36 and a plurality of wheel-contacting projections 48₁-48_{N} that project from the inner surface 55 and are positioned to contact at least some of the wheels 23₁, 23₂, 24, 26₁, 26₂, 28₁-28 to do at least one of driving (i.e., imparting motion to) the track 22 and guiding the track 22. The wheel-contacting projections 48₁-48_{N} can be referred to as “wheel-contacting lugs”. Furthermore, since each of them is used to do at least one of driving the track 22 and guiding the track 22, the wheel-contacting lugs 48₁-48_{N} can be referred to as “drive/guide projections” or “drive/guide lugs”. In some examples of implementation, a drive/guide lug 48ᵢ may interact with the drive wheel 24 to drive the track 22, in which case the drive/guide lug 48ᵢ is a drive lug. In other examples of implementation, a drive/guide lug 48ᵢ may interact with the front and rear idler wheels 23₁, 23₂, 26₁, 26₂ and/or the roller wheels 28₁-28 to guide the track 22 to maintain proper track alignment and prevent de-tracking without being used to drive the track 22, in which case the drive/guide lug 48ᵢ is a guide lug. In yet other examples of implementation, a drive/guide lug 48ᵢ may both (i) interact with the drive wheel 24 to drive the track and (ii) interact with the idler wheels 23₁, 23₂, 26₁, 26₂ and/or the roller wheels 28₁-28₆ to guide the track 22 to maintain proper track alignment and prevent de-tracking, in which case the drive/guide lug 48ᵢ is both a drive lug and a guide lug.

In this embodiment, the drive/guide lugs 48₁-48_{N} interact with the drive wheel 24 in order to cause the track 22 to be driven, and also interact with the idler wheels 23₁, 23₂, 26₁, 26₂ and the roller wheels 28₁-28₆ in order to guide the track 22 as it is driven by the drive wheel 24 to maintain proper track alignment and prevent de-tracking. The drive/guide lugs 48₁-48_{N} are thus used to both drive the track 22 and guide the track 22 in this embodiment.

In this example of implementation, the drive/guide lugs 48₁-48_{N} are arranged in a single row disposed longitudinally along the inner side 45 of the track 22. The drive/guide lugs 48₁-48_{N} may be arranged in other manners in other examples of implementation (e.g., in a plurality of rows that are spaced apart along the widthwise direction of the track 22).

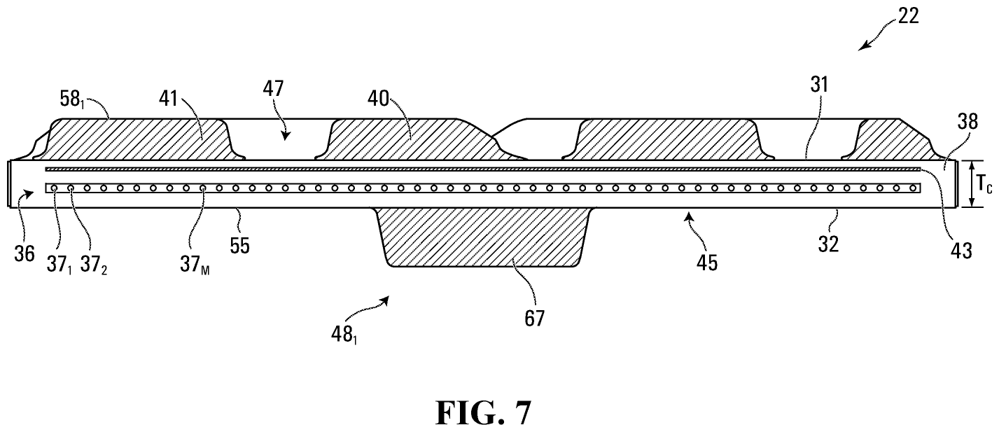

The drive/guide lugs 48₁-48_{N} may have any suitable shape. With additional reference to FIG. 8, each drive/guide lug 48ᵢ has a periphery 69 which, in this embodiment, includes a front surface 80₁, a rear surface 80₂, two lateral surfaces 81₁, 81₂, and a top surface 86. The front surface 80₁ and the rear surface 80₂ are opposed to one another along the longitudinal direction of the track 22. In this embodiment where the drive/guide lug 48ᵢ is used to drive the track 22, each of the front surface 80₁ and the rear surface 80₂ constitutes a drive surface which can be contacted by a drive member of the drive wheel 24 that pushes against it to impart motion to the track 22. The two lateral surfaces 81₁, 81₂ are laterally opposed and may contact the roller wheels 28₁-28₆, the drive wheel 24 and/or the idler wheel 26 such as to prevent excessive lateral movement of the track 22 relative the wheels and to thus prevent de-tracking. Although it has a certain shape in this embodiment, the periphery 69 of the drive/guide lug 48ᵢ may have various other shapes in other embodiments.

Each drive/guide lug 48ᵢ has a front-to-rear dimension L_{L} in the longitudinal direction of the endless track 22 and a side-to-side dimension L_{W} in the widthwise direction of the endless track 22. In some cases, the front-to-rear dimension L_{L} may be a width of the drive/guide lug 48ᵢ while the side-to-side dimension L_{W} may be a length of the drive/guide lug 48ᵢ. In other cases, the front-to-rear dimension L_{L} may be a length of the drive/guide lug 48ᵢ while the side-to-side dimension L_{W} may be a width of the drive/guide lug 48ᵢ. In yet other cases, the front-to-rear dimension L_{L} and the side-to-side dimension L_{W} may be substantially the same. The drive/guide lug 48ᵢ also has a height H.

In this embodiment, the drive/guide lug 48ᵢ is configured to pass between respective pairs of the idler wheels 23₁, 23₂, 26₁, 26₂ and/or the roller wheels 28₁-28₆ when they are aligned with one another, such that the lateral surfaces 81₁, 81₂ of each drive/guide lug 48ᵢ face respecting ones of the idler wheels 23₁, 23₂, 26₁, 26₂ and/or the roller wheels 28₁-28₆ when they are aligned with one another.

In this embodiment, each drive/guide lug 48ᵢ is an elastomeric drive/guide lug in that it comprises elastomeric material 67. The elastomeric material 67 can be any polymeric material with suitable elasticity. More particularly, in this embodiment, the elastomeric material 67 includes rubber. Various rubber compounds may be used and, in some cases, different rubber compounds may be present in different areas of the drive/guide lug 48ᵢ. In other embodiments, the elastomeric material 67 may include another elastomer in addition to or instead of rubber (e.g., polyurethane elastomer). The drive/guide lugs 48₁-48_{N} may be provided on the inner side 45 in various ways. For example, in this embodiment, the drive/guide lugs 48₁-48_{N} are provided on the inner side 45 by being molded with the carcass 36.

The ground-engaging outer side 47 comprises a ground-engaging outer surface 31 of the carcass 36 and a tread pattern 40 to enhance traction on the ground. The tread pattern 40 comprises a plurality of traction projections 58₁-58_{T} projecting from the ground-engaging outer surface 31, spaced apart in the longitudinal direction of the endless track 22 and engaging the ground to enhance traction. The traction projections 58₁-58_{T} may be referred to as “tread projections” or “traction lugs”.

The traction lugs 58₁-58_{T} may have any suitable shape. In this embodiment, each of the traction lugs 58₁-58_{T} has an elongated shape and is angled, i.e., defines an oblique angle (i.e., an angle that is not a right angle or a multiple of a right angle), relative to the longitudinal direction of the track 22. The traction lugs 58₁-58_{T} may have various other shapes in other examples (e.g., curved shapes, shapes with straight parts and curved parts, etc.).

In this embodiment, each traction lug 58ᵢ is an elastomeric traction lug in that it comprises elastomeric material 41. The elastomeric material 41 can be any polymeric material with suitable elasticity. More particularly, in this embodiment, the elastomeric material 41 includes rubber. Various rubber compounds may be used and, in some cases, different rubber compounds may be present in different areas of the traction lug 58ᵢ. In other embodiments, the elastomeric material 41 may include another elastomer in addition to or instead of rubber (e.g., polyurethane elastomer). The traction lugs 58₁-58_{T} may be provided on the ground-engaging outer side 47 in various ways. For example, in this embodiment, the traction lugs 58₁-58_{T} are provided on the ground-engaging outer side 47 by being molded with the carcass 36.

The track 22 may be constructed in various other manners in other embodiments. For example, in some embodiments, the track 22 may have recesses or holes that interact with the drive wheel 24 in order to cause the track 22 to be driven (e.g., in which case the drive/guide lugs 48₁-48_{N} may be used only to guide the track 22 without being used to drive the track 22, i.e., they may be “guide lugs” only), and/or the ground-engaging outer side 47 of the track 22 may comprise various patterns of traction lugs.

The drive wheel 24 is rotatable about an axis of rotation 72 by power derived from the prime mover 14 to drive the track 22. That is, power generated by the prime mover 14 and delivered over the powertrain 15 of the agricultural vehicle 10 can rotate a final drive axle 56, which causes rotation of the drive wheel 24, which in turn imparts motion to the track 22.

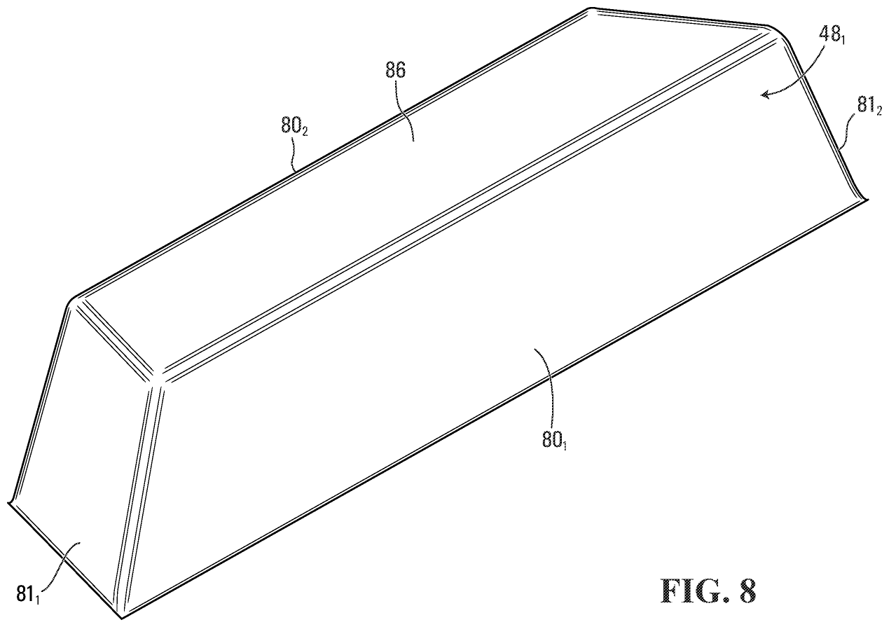

With additional reference to FIG. 9, in this embodiment, the drive wheel 24 comprises a drive sprocket comprising a plurality of drive members 52₁-52_{B} spaced apart along a circular path to engage the drive/guide lugs 48₁-48_{N} of the track 22 in order to drive the track 22. The drive wheel 24 and the track 22 thus implement a “positive drive” arrangement. More particularly, in this embodiment, the drive wheel 24 comprises two side discs 50₁, 50₂ which are co-centric and turn about a common axle 51 and between which the drive members 52₁-52_{B} extend near respective peripheries of the side discs 50₁, 50₂. In this example, the drive members 52₁-52_{B} are thus drive bars that extend between the side discs 50₁, 50₂. The drive wheel 24 and the track 22 have respective dimensions allowing interlocking of the drive bars 52₁-52_{B} of the drive wheel 24 and the drive/guide lugs 48₁-48_{N} of the track 22. Adjacent ones of the drive bars 52₁-52_{B} define an interior space 53 between them to receive one of the drive/guide lugs 48₁-48_{N}. Adjacent ones of the drive/guide lugs 48₁-48_{N} define an inter-lug space 39 between them to receive one of the drive bars 52₁-52_{B}. The drive/guide lugs 48₁-48_{N} and the drive bars 52₁-52_{B} have a regular spacing that allows interlocking of the drive/guide lugs 48₁-48_{N} and the drive bars 52₁-52_{B} over a certain length of the drive wheel's circumference.

The drive wheel 24 may be configured in various other ways in other embodiments. For example, in other embodiments, the drive wheel 24 may not have any side discs such as the side discs 50₁, 50₂. As another example, in other embodiments, instead of being drive bars, the drive members 52₁-52_{B} may be drive teeth that are distributed circumferentially along the drive wheel 24 or any other type of drive members. As another example, in embodiments where the track 22 comprises recesses or holes, the drive wheel 24 may have teeth that enter these recesses or holes in order to drive the track 22. As yet another example, in some embodiments, the drive wheel 24 may frictionally engage the inner side 45 of the track 22 in order to frictionally drive the track 22 (i.e., the drive wheel 24 and the track 22 may implement a “friction drive” arrangement).

The front idler, rear idler, and roller wheels 23₁, 23₂, 26₁, 26₂, 28₁-28₆ are not driven by power supplied by the prime mover 14, but are rather used to do at least one of supporting part of the weight of the agricultural vehicle 10 on the ground via the track 22, guiding the track 22 as it is driven by the drive wheel 24, and tensioning the track 22. More particularly, in this embodiment, the front and rear idler wheels 23₁, 23₂, 26₁, 26₂ maintain the track 22 in tension and help to support part of the weight of the agricultural vehicle 10 on the ground via the track 22. The roller wheels 28₁-28₆ roll on a rolling path 33 of the inner side 45 of the track 22 along the bottom run 66 of the track 22 to apply the bottom run 66 on the ground. In this case, as they are located between frontmost and rearmost ones of the wheels of the track system 16, the roller wheels 28₁-28₆ can be referred to as “mid-rollers”.

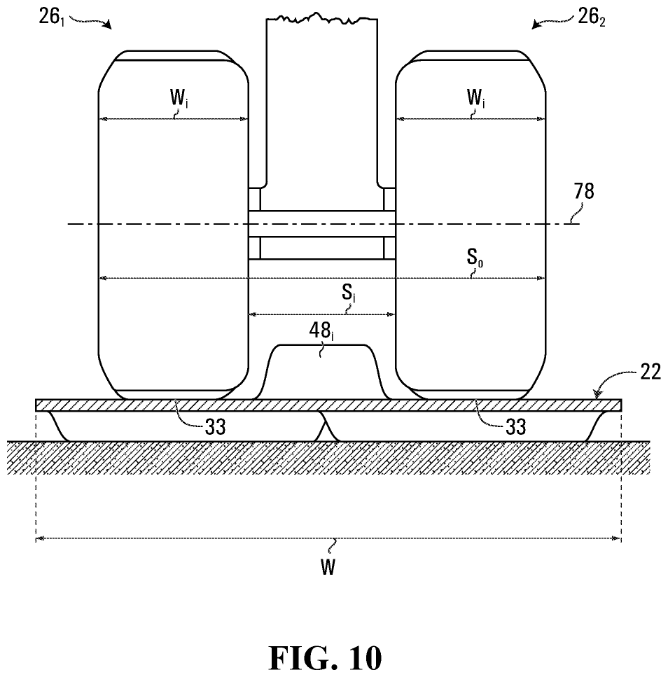

As shown in FIG. 11, in this embodiment, each one of the front and rear idler wheels 23₁, 23₂, 26₁, 26₂ is rotatable about a respective axis of rotation 78, and the axis of rotation 72 of the drive wheel 24 is disposed between (i) the axes of rotation 78 of the front idler wheels 23₁, 23₂, and (ii) the axes of rotation 78 of the rear idler wheels 26₁, 26₂ in the longitudinal direction of the track system 16. A distance between the axis of rotation 72 of the drive wheel 24 and the respective axes of rotation 78 of the front idler wheels 23₁, 23₂ may correspond to a distance between the axis of rotation 72 of the drive wheel 24 and the respective axes of rotation 78 of the rear idler wheels 26₁, 26₂.

Each one of the front and rear idler wheels 23₁, 23₂, 26₁, 26₂ may comprise a pair of lateral sides 94₁, 94₂ opposite one another and a peripheral side 96 between the lateral sides 94₁, 94₂. The peripheral side 96 is configured to roll on the inner side 45 of the track 22. More particularly, in this embodiment, the front and rear idler wheels 23₁, 23₂, 26₁, 26₂ roll on the inner side 45 of the track 22 such that, as the front and rear idler wheels 23₁, 23₂, 26₁, 26₂ roll, these drive/guide lugs pass next to the respective ones of the front and rear idler wheels 23₁, 23₂, 26₁, 26₂.

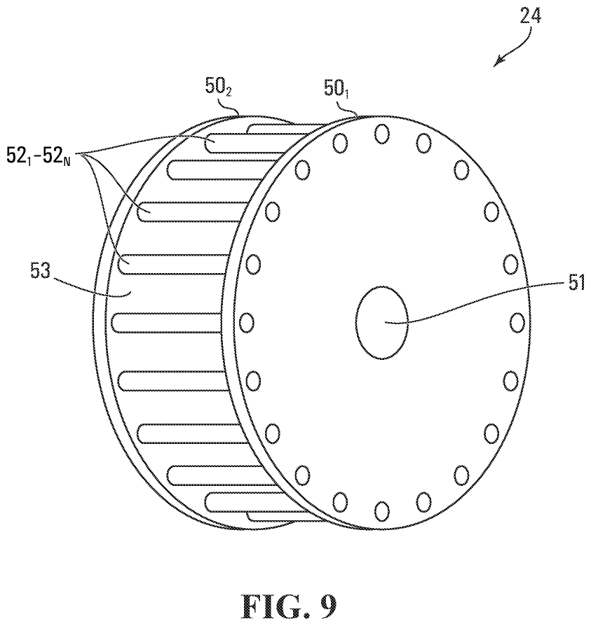

As shown in FIG. 10, in this embodiment, the front idler wheels 23₁, 23₂ are spaced from one another in the widthwise direction of the track system 16, the rear idler wheels 26₁, 26₂ are spaced from one another in the widthwise direction of the track system 16, and a spacing S_{I} of laterally-adjacent ones of the front idler wheels 23₁, 23₂ and the rear idler wheels 26₁, 26₂ may have any suitable value. In some embodiments, this spacing S_{I} may be reduced (e.g., compared to conventional track systems that are comparably dimensioned) because of how the track 22 is aligned and tensioned. For example, in some embodiments, a ratio of the spacing S_{I} of the rear idler wheels 26₁, 26₂ in the widthwise direction of the track system 16 over a width W of the track 22 may be no more than 0.2 in some embodiments no more than 0.18, in some embodiments no more than 0.15, and in some embodiments even less. As another example, in some embodiments, a ratio of the spacing S_{I} of the rear idler wheels 26₁, 26₂ in the widthwise direction of the track system 16 over a width Wᵢ of a given one of the rear idler wheels 26₁, 26₂ may be no more than 1, in some embodiments no more than 0.9, in some embodiments no more than 0.8, and in some embodiments even less. As another example, in some embodiments, a ratio of the spacing Sᵢ of the rear idler wheels 26₁, 26₂ in the widthwise direction of the track system 16 over a span S_{O} of the rear idler wheels 26₁, 26₂ in the widthwise direction of the track system 16 may be no more than 0.3, in some embodiments no more than 0.25, in some embodiments no more than 0.2, and in some embodiments even less.

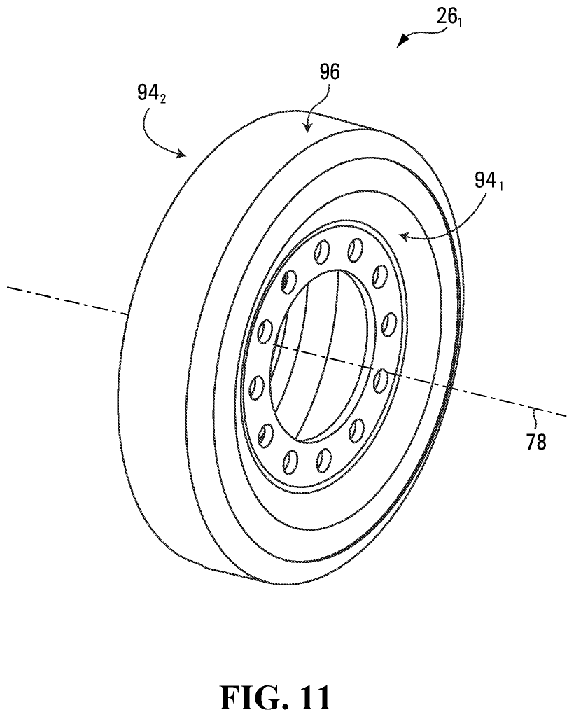

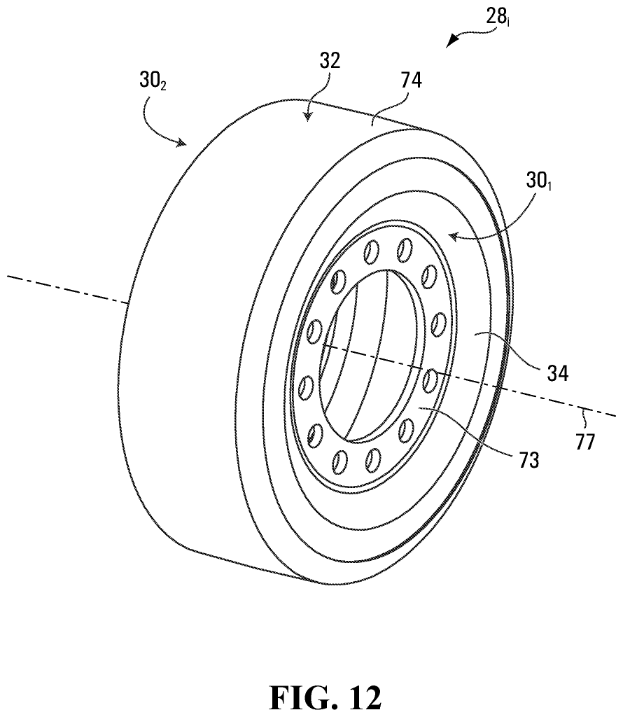

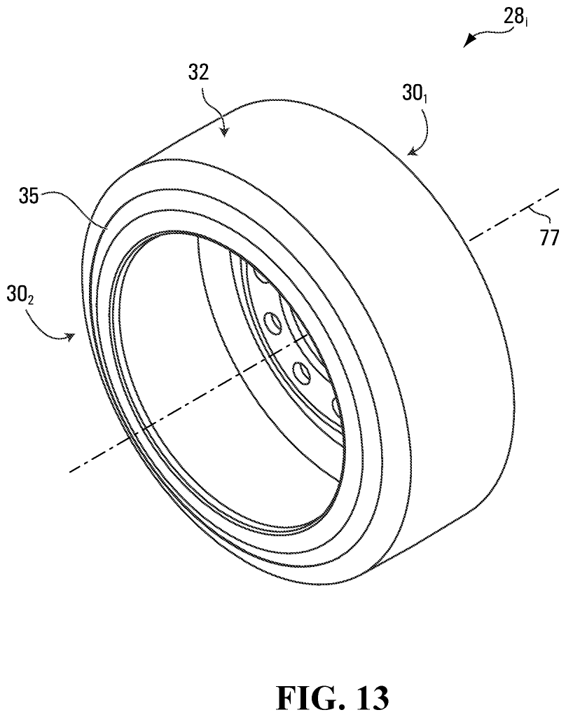

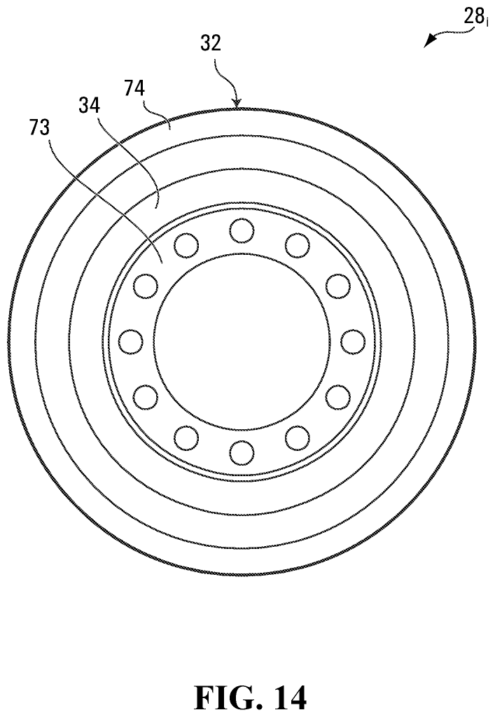

With additional reference to FIGS. 12 to 15, each mid-roller 28ᵢ has an axis of rotation 77 and comprises a hub portion 73, a rim portion 74, and a radially-extending portion 34 between the hub portion 73 and the rim portion 74. The hub portion 73 is an inner portion of the mid-roller 28ᵢ which is associated with a hub 75 receiving an axle 76 for the mid-roller 28ᵢ. The rim portion 74 is an outer portion of the mid-roller 28ᵢ which contacts the inner side 45 of the endless track 22. The radially-extending portion 34 is an intermediate portion of the mid-roller 28ᵢ which extends radially between the hub portion 73 and the rim portion 74.

The mid-roller 28ᵢ comprises a pair of lateral sides 30₁, 30₂ opposite one another and a peripheral side 32 between the lateral sides 30₁, 30₂. The peripheral side 32 rolls on the inner side 45 of the track 22 to apply the bottom run 66 of track 22 on the ground. More particularly, in this embodiment, the mid-roller 28ᵢ rolls on the rolling path 33 which is delimited by some of the drive/guide lugs 48₁-48_{N} such that, as the mid-roller 28ᵢ rolls, these drive/guide lugs pass next to the mid-roller 28ᵢ.

In this embodiment, the mid-rollers 28₁-28₆ may be disposed in corresponding pairs that are spaced apart in the longitudinal direction of the track system 16, and the mid-roller 28ᵢ may engage a significant extent of the width W of the track 22. For example, in some embodiments, a ratio of a width R_{w} of the mid-roller 28ᵢ over the width W of the track 22 may be at least 0.2, in some cases at least 0.3, in some cases at least 0.4, and in some cases even more.

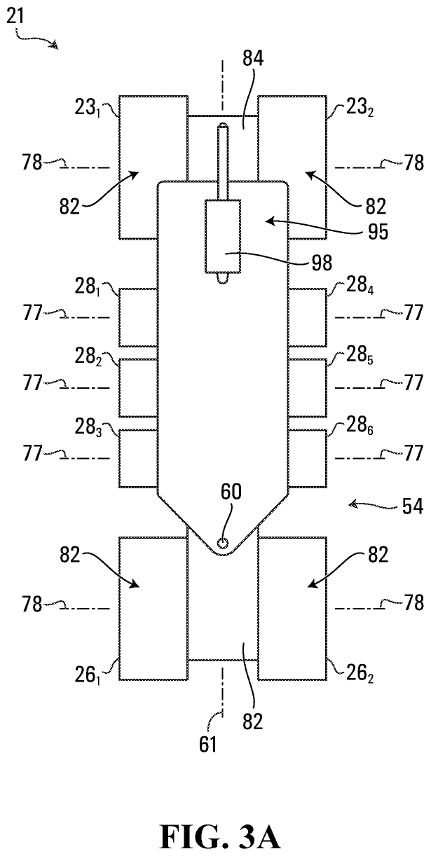

Moreover, as shown in FIGS. 2 and 3A to 3C, the track system 16 may comprise a tensioner 95 configured to control a tension of the track 22. For instance, in this embodiment, the tensioner 95 comprises an actuator mounted at one end to the frame 13 of the track system 16 and at another end to a hub of the front idler wheels 23₁, 23₂. This allows the tensioner 95 to modify a distance between the front idler wheels 23₁, 23₂ and the rear idler wheels 26₁, 26₂ in the longitudinal direction of the track system 16, thereby affecting the tension of the track 22.

In this embodiment, the tensioner 95 is disposed to exert a force closer to the front idler wheels 23₁, 23₂ than to the rear idler wheels 26₁, 26₂ to control the tension of the track 22. For example, the tensioner 95 may be disposed closer to the front idler wheels 23₁, 23₂ than to the rear idler wheels 26₁, 26₂ in the longitudinal direction of the track system 16.

In this embodiment, the tensioner 95 is an active tensioner. More particularly, in this embodiment, the tensioner 95 comprises a piston-cylinder unit 98.

The tensioner 95 may comprise a tensioning link 84 mounted between the tensioner 95 and respective axles 82 of the front idler wheels 23₁, 23₂. Specifically, in this embodiment, the tensioning link 84 is pivotally connected to the lower portion 46 of the frame 13.

With additional reference to FIGS. 3A to 3C, in this embodiment, the track system 16 comprises an alignment mechanism 54 configured to adjust an orientation of the rear idler wheels 26₁, 26₂ relative to the longitudinal direction of the track system 16. Without being bound by theory, in some cases, since a segment of the track 22 between the drive wheel 24 and the rear idler wheels 26₁, 26₂ may be subject to less longitudinal stresses than a segment of the track 22 between the drive wheel 24 and the front idler wheels 23₁, 23₂, this configuration may allow the track 22 to be subject to reduced stress during alignment, thereby increasing durability of the track 22 and the alignment mechanism 54, increasing efficacy of the track system 16, and reducing de-tensioning of the track 22.

The alignment mechanism 54 may comprise a pivot 60 and an alignment link 62 pivotable about a pivot axis 88 of the pivot 60 to adjust the respective orientations of the rear idler wheels 26₁, 26₂ relative to the longitudinal direction of the track system 16. In order to achieve this, the pivot axis 88 of the pivot 60 may be transversal to the widthwise direction of the track system 16. In particular, in this embodiment, the pivot axis 88 of the pivot 60 is configured to be perpendicular to the widthwise direction of the track system 16 when the track 22 and the track-engaging assembly 24 are straight and when the respective axes of rotation 78 of the rear idler wheels 26₁, 26₂ are parallel to the widthwise direction of the track system 16. In this example, the pivot axis 62 of the pivot 60 is configured to be substantially parallel to the heightwise direction of the track system 16.

In this embodiment, the alignment link 62 may extend to respective axles 82 of the rear idler wheels 26₁, 26₂.

The alignment mechanism 54 may be configured to adjust the orientation of the rear idler wheels 26₁, 26₂ by any suitable extent. For example, in some embodiments, the alignment mechanism 54 is configured to adjust the orientation of the rear idler wheels 26₁, 26₂ relative to the longitudinal direction of the track system 16 by a range of angles α of no more than 10°, in some embodiments of no more than 8°, in some embodiments of no more than 5°, and in some embodiments of even less.

The track system 16 may be implemented in any other suitable manner in other embodiments.

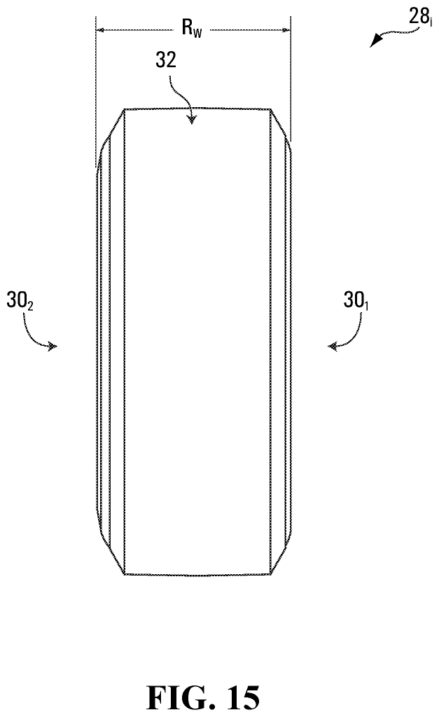

For example, as shown in FIG. 16, in some embodiments, the tensioner 95 is disposed to exert a force closer to the rear idler wheels 26₁, 26₂ than to the front idler wheels 23₁, 23₂ to control the tension of the track 22. For example, the tensioner 95 may be disposed closer to the rear idler wheels 26₁, 26₂ than to the front idler wheels 23₁, 23₂ in the longitudinal direction of the track system 16. In this variant, the alignment mechanism 54 may further comprise a tensioning link 84 mounted between the tensioner 95 and the respective axles 82 of the rear idler wheels 26₁, 26₂. Specifically, in this embodiment, the alignment link 62 is pivotally connected to the tensioning link 84.

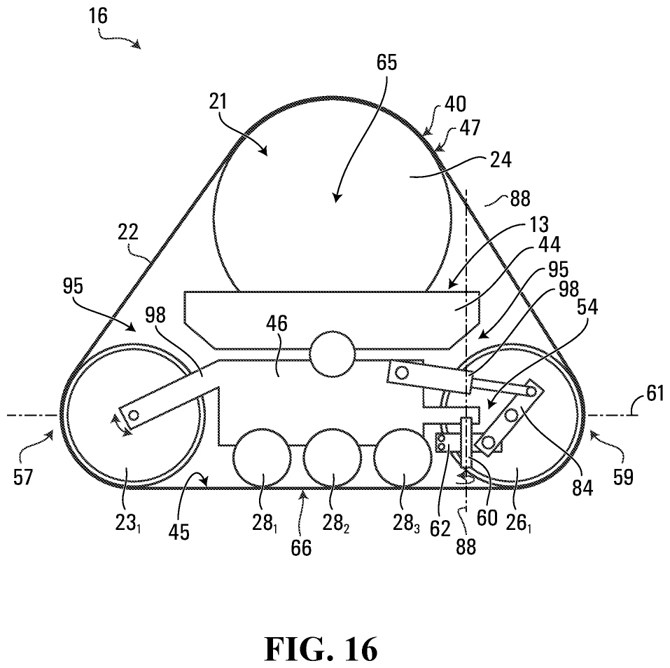

As another example, as shown in FIG. 17, in some embodiments, the alignment mechanism 54 may comprise an actuator 92 that is responsive to a command 90 from a processing apparatus 112 to adjust the orientation of the rear idler wheels 26₁, 26₂ relative to the longitudinal direction of the track system 16. For example, the processing apparatus 112 may comprise a power source 114 and a signal generator 116 which are configured to generate and send the command 90 to the actuator 92 in response to a pre-determined event, such as a braking command, an acceleration command or a turn command, which would command the actuator 92 to activate the alignment mechanism 54 to adjust an orientation of the rear idler wheels 26₁, 26₂ relative to the longitudinal direction of the track system 16.

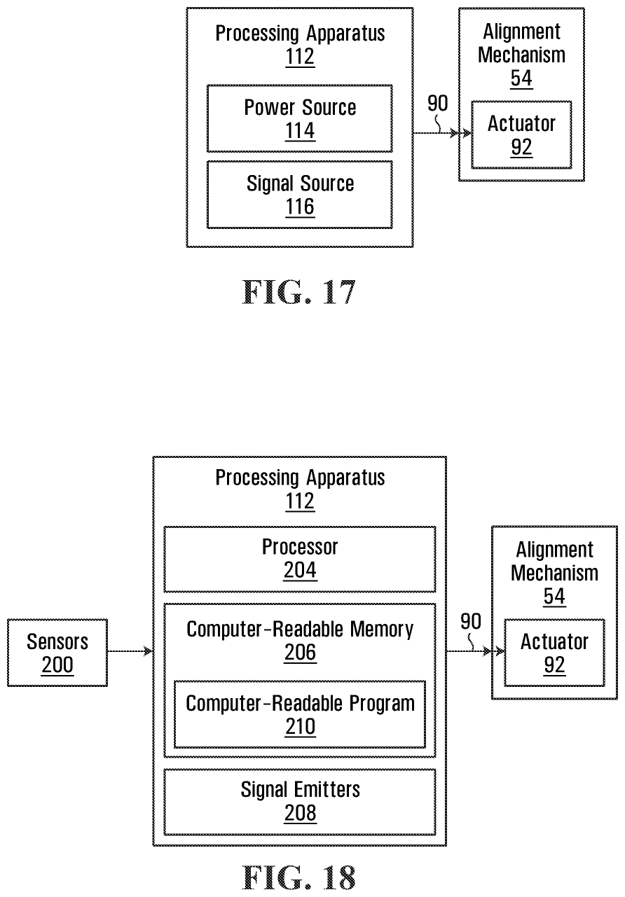

As another example, in some embodiments, as shown in FIG. 18, the agricultural vehicle 10 is further equipped with sensors 200 to sense a parameter of the agricultural vehicle 10 (e.g. its speed, its inclination, its acceleration, etc.) and/or of the track system 16 (e.g. a tension of the track 22, a load distribution of the track system 16, an position of the alignment mechanism 54, a length of the tensioner 95, a speed of extension/contraction of the tensioner 95) and/or of a display computer which may be reactive to a user command (e.g. using a push-button, a radio button, a touch-screen, etc.). The processing apparatus 112 may be a computer implementing a processor 204, signal emitters 208 and computer-readable memory 206 which comprises a computer-readable program 210 to treat the signal of the sensors 200 and command the emitters 208 to generate an electric signal and send it to the actuator 92 of the alignment mechanism 54 to control a state of the alignment mechanism 54. In particular, in this variant, the command 60 is issued by the processing apparatus 112 based on a side load on the track system 16.

Although the agricultural vehicle 10 illustrated in FIG. 1 is an agricultural tractor comprising four track systems 16, different types of agricultural vehicles configured differently (e.g., having a different number of track systems) may implement improvements based on principles disclosed herein. For instance, in some embodiments, the agricultural vehicle 10 may be provided with two track systems 16 rather than four (i.e., one track system 516 at each side of the agricultural vehicle 10).

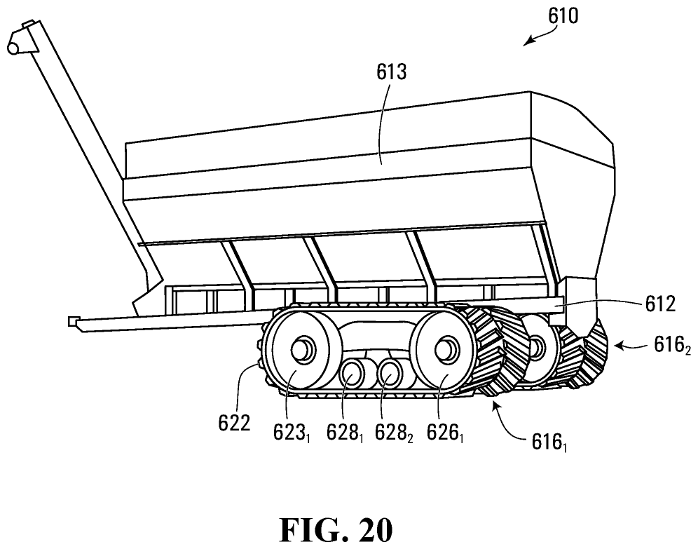

Furthermore, the work implement 18 that is drawn by the agricultural vehicle 10 or the agricultural vehicle 510 may implement the improvements disclosed herein. For instance, with additional reference to FIG. 20, the work implement 18 may comprise a trailed vehicle 610 comprising a frame 612, a body 613 (e.g., a container) and track systems 616₁, 616₂. In this example, the trailed vehicle 610 is a harvest cart. In other examples, the trailed vehicle 610 may be a fertilizer cart, a sprayer, a planter or any other suitable type of trailed vehicle. Each track system 616 of the trailed vehicle 610 comprises front (i.e., leading) idler wheels 623₁, 623₂ at a first longitudinal end portion of the track system 616, rear (i.e., trailing) idler wheels 626₁, 626₂ at a second longitudinal end portion of the track system 616 opposite the first longitudinal end portion, and a plurality of mid-rollers 628₁-628₄ intermediate the front idler wheels 623₁, 623₂ and the rear idler wheels 626₁, 626₂. The track system 616 further comprises a track 622 disposed around the wheels 626₁, 626₂, 626₁, 626₂, 628₁-628₄. The track system 616 may implement the bogie 85 as described above. Additionally or alternatively, the track 622 may be configured in a manner similar to the track 22 as described above.

In this example, the trailed vehicle 610 is not motorized in that it does not comprise a prime mover for driving the track systems 616₁, 616₂. Rather, the trailed vehicle 610 is displaced by the agricultural vehicle 10 or the agricultural vehicle 510 to which the trailed vehicle 610 is attached. However, in some examples, the trailed vehicle 610 may be motorized. That is, the trailed vehicle 610 may comprise a prime mover for driving a drive wheel of each track system 616. For example, instead of comprising rear idler wheels 626₁, 626₂, the track system 616 may comprise a drive wheel for driving the track 622.

Although in embodiments considered above the vehicle 10 is an agricultural vehicle operable by a user from the operator cabin 20, in some embodiments, the vehicle 10 may be operable by a user remotely. In some embodiments, the vehicle 10 may comprise autonomy features, allowing the vehicle 10 to be semi-autonomous and/or entirely autonomous. In some embodiments, the vehicle 10 may be free of any operator cabin.

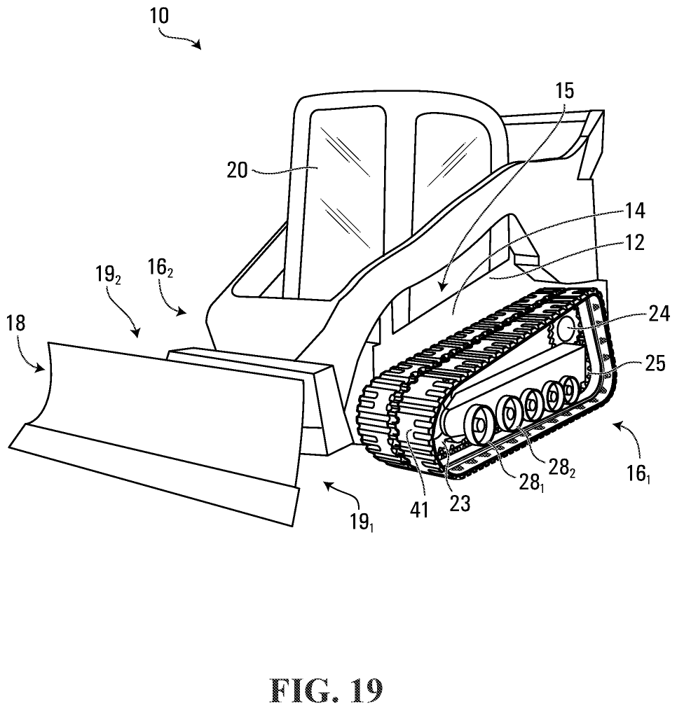

While in embodiments considered above the vehicle 10 is an agricultural vehicle, in other embodiments, the vehicle 10 may be an industrial vehicle such as a construction vehicle (e.g., a loader, a telehandler, a bulldozer, an excavator, etc.) for performing construction work or a forestry vehicle (e.g., a feller-buncher, a tree chipper, a knuckleboom loader, etc.) for performing forestry work, a military vehicle (e.g., a combat engineering vehicle (CEV), etc.) for performing military work, an all-terrain vehicle (ATV), a snowmobile, or any other vehicle operable off paved roads. For example, in some embodiments, as shown in FIG. 19, the vehicle 10 may be a construction vehicle that is equipped with the track systems 16.

Although operable off paved roads, the vehicle 10 may also be operable on paved roads in some cases.

In some examples of implementation, any feature of any embodiment described herein may be used in combination with any feature of any other embodiment described herein.

Certain additional elements that may be needed for operation of some embodiments have not been described or illustrated as they are assumed to be within the purview of those of ordinary skill in the art. Moreover, certain embodiments may be free of, may lack and/or may function without any element that is not specifically disclosed herein.

In case of any discrepancy, inconsistency, or other difference between terms used herein and terms used in any document incorporated by reference herein, meanings of the terms used herein are to prevail and be used.

Although various embodiments and examples have been presented, this was for purposes of description, but should not be limiting. Various modifications and enhancements will become apparent to those of ordinary skill in the art.

1. A track system for traction of a vehicle, the track system comprising:
a track that is elastomeric and comprises a ground-engaging outer surface configured to engage a ground and an inner surface opposite to the ground-engaging outer surface;
a plurality of track-contacting wheels for driving and guiding the track around the track-contacting wheels, the track-contacting wheels including:
a drive wheel configured to drive the track;
a front idler wheel and a rear idler wheel spaced apart in a longitudinal direction of the track system; and
a plurality of roller wheels configured to roll on a lower run of the track and disposed between the front idler wheel and the rear idler wheel in the longitudinal direction of the track system; and
an alignment mechanism configured to adjust an orientation of the rear idler wheel relative to the longitudinal direction of the track system.

2. The track system of claim 1, wherein an axis of rotation of the drive wheel is disposed between an axis of rotation of the front idler wheel and an axis of rotation of the rear idler wheel in the longitudinal direction of the track system.

3. The track system of claim 1, comprising a tensioner configured to control a tension of the track.

4. The track system of claim 3, wherein the tensioner is disposed to exert a force closer to the front idler wheel than to the rear idler wheel or closer to the rear idler wheel than to the front idler wheel to control the tension of the track.

5. The track system of claim 3, wherein the tensioner is disposed closer to the front idler wheel than to the rear idler wheel or closer to the rear idler wheel than to the front idler wheel in the longitudinal direction of the track system.

6. (canceled)

7. (canceled)

8. The track system of claim 3, wherein the tensioner is an active tensioner.

9. The track system of claim 3, wherein the tensioner comprises a piston-cylinder unit.

10. The track system of claim 3, wherein the alignment mechanism comprises a pivot and an alignment link pivotable about a pivot axis of the pivot to adjust the orientation of the rear idler wheel relative to the longitudinal direction of the track system.

11. The track system of claim 8, wherein the pivot axis of the alignment mechanism is substantially parallel to a heightwise direction of the track system.

12. (canceled)

13. The track system of claim 8, comprising a tensioning link mounted between the tensioner and an axle of the rear idler wheel, wherein the alignment link is pivotally connected to the tensioning link.

14. (canceled)

15. The track system of claim 2, wherein a distance between the axis of rotation of the drive wheel and the axis of rotation of the front idler wheel corresponds to a distance between the axis of rotation of the drive wheel and the axis of rotation of the rear idler wheel.

16. The track system of claim 2, wherein a distance between the axis of rotation of the drive wheel and the axis of rotation of the front idler wheel is different from a distance between the axis of rotation of the drive wheel and the axis of rotation of the rear idler wheel.

17. (canceled)

18. The track system of claim 1, wherein the alignment mechanism is configured to adjust the orientation of the rear idler wheel relative to the longitudinal direction of the track system by no more than 10°.

19. (canceled)

20. (canceled)

21. The track system of claim 1, wherein: the rear idler wheel is a first rear idler wheel, the front idler wheel is a first front idler wheel, the track-contacting wheels include a second rear idler wheel spaced from the first rear idler wheel in a widthwise direction of the track system and second front idler wheel spaced from the first front idler wheel in the widthwise direction of the track system, and the alignment mechanism is configured to adjust an orientation of the second rear idler wheel relative to the longitudinal direction of the track system.

22. The track system of claim 14, wherein a ratio of a spacing of the first rear idler wheel and the second rear idler wheel in the widthwise direction of the track system over a width of the track is no more than 0.2.

23. (canceled)

24. (canceled)

25. The track system of claim 14, wherein a ratio of a spacing of the first rear idler wheel and the second rear idler wheel in the widthwise direction of the track system over a width of the first rear idler wheel is no more than 1.

26. (canceled)

27. (canceled)

28. (canceled)

29. (canceled)

30. (canceled)

31. The track system of claim 1, wherein the alignment mechanism is responsive to a command from a processing apparatus to adjust the orientation of the rear idler wheel relative to the longitudinal direction of the track system.

32. The track system of claim 1, wherein the command is issued by the processing apparatus based on a side load on the track system.

33. (canceled)

34. A track system for traction of a vehicle, the track system comprising:
a track that is elastomeric and comprises a ground-engaging outer surface configured to engage a ground and an inner surface opposite to the ground-engaging outer surface;
a plurality of track-contacting wheels for driving and guiding the track around the track-contacting wheels, the track-contacting wheels including:
a drive wheel configured to drive the track;
a front idler wheel and a rear idler wheel spaced apart in a longitudinal direction of the track system; and
a plurality of roller wheels configured to roll on a lower run of the track and disposed between the front idler wheel and the rear idler wheel in the longitudinal direction of the track system;
a tensioner configured to control a tension of the track, the tensioner being disposed to exert a force closer to the front idler wheel than to the rear idler wheel to control the tension of the track; and
an alignment mechanism configured to adjust an orientation of the rear idler wheel relative to the longitudinal direction of the track system.

35. A track system for traction of a vehicle, the track system comprising:
a track that is elastomeric and comprises a ground-engaging outer surface configured to engage a ground and an inner surface opposite to the ground-engaging outer surface;
a plurality of track-contacting wheels for driving and guiding the track around the track-contacting wheels, the track-contacting wheels including:
a drive wheel configured to drive the track;
a front idler wheel and a rear idler wheel spaced apart in a longitudinal direction of the track system; and—a plurality of roller wheels configured to roll on a lower run of the track and disposed between the front idler wheel and the rear idler wheel in the longitudinal direction of the track system;
a tensioner configured to control a tension of the track, the tensioner being disposed to exert a force closer to the rear idler wheel than to the front idler wheel to control the tension of the track; and
an alignment mechanism configured to adjust an orientation of the rear idler wheel relative to the longitudinal direction of the track system.

36. (canceled)
